(19) United States
(12) Patent Application Publication
(10) Pub. No.: US 2005/0286710 A1
(43) Pub. Date: Dec. 29, 2005

(54) Broadband XDSL transceiver

(75) Inventors: Stefan Barkaro, Akersberga (SE); Torbjorn Randahl, Nacka (SE); Carl-Mikael Johansson, Stockholm (SE); Lars Karlsson, Upplands Vasby (SE); Bo Bokinge, Bromma (SE)

Correspondence Address: Maginot, Moore & Beck;Bank One Tower, Suite 3000, 111 Monument Circle, Indianapolis, IN, 46204, US

(73) Assignee: Infineon Technologies AG, Munchen (DE)

(21) Appl. No.: 11/170,395

(22) Filed: Jun. 29, 2005

(30) Foreign Application Priority Data
Jun. 29, 2004 (EP) 04015203.5

(51) Int. Cl. H04M 7/04

(52) U.S. Cl. 379/398

(57) ABSTRACT

Broadband xDSL transceiver for transmitting and receiving signals in a predetermined broadband frequency range (ΔF) via a signal line which has a complex line impedance (Z_{L}), wherein the xDSL transceiver (1) comprises
a line driver (3) for driving a transmission signal applied to a signal input (4a, 4b) of said line driver (3) via said signal line;
a receiver (8) for evaluating a reception signal received via said signal line and applied to a signal input of said receiver (8);
an echo canceling bridge (10) for canceling the transmission signal at the signal input (9a, 9b) of said receiver (8);
a sense impedance (11) connected to the signal line;
a feedback resistor network (15a, 15b) provided between the sense impedance (11) and the signal input (4a, 4b) of said line driver (3) performing a synthesized termination impedance (Z_{T}) of the xDSL transceiver (1) as a product of the sense impedance and an impedance synthesis factor (G);
wherein the sense impedance (11) is a complex impedance (Z_{S}) so that the synthesized termination impedance (Z_{T}) matches the line impedance (Z_{L}) over the predetermined broadband frequency range (ΔF).

The invention refers to a broadband xDSL transceiver having a constant transmission gain over a broad frequency range.

The usual subscriber line technology (DSL) offers fast data transfer on existing copper based telephone lines. In DSL broadband data signals are transmitted on significantly higher frequencies than traditional narrow band telephone signals. Since the narrow band telephone signals and the broadband data signals are both transmitted over the same subscriber line, splitter devices are provided for splitting and recombining the two types of signals at both ends of the subscriber line, i.e. at the central office or switching center, and at the end terminals of the subscriber location. There are various types of DSLs that have envolved over the last years such as ADSL, HDSL, SDSL and VDSL.

Multitone modulation is the basis of the DMT version of ADSL as well as some multi-carrier versions of VDSL. This type of modulation is also called orthogonal frequency division multiplexing (OFDM).

In order to transmit the xDSL data signals over the telephone line which normally consists of a pair of copper wires, the central office is provided with line drivers. The line driver compensates for the attenuation of the telephone line has to comply with the PSD mask requirement of the respective DSL standard. The line driver amplifiers the line coded xDSL signal so that it is received downstream at the subscriber location with sufficient signal intensity.

In xDSL applications signals are transmitted and received simultaneously. The transmission signal is amplified by the line driver and the reception signal is received and evaluated by a receiver. The line driver output and the receiver input are both connected to the signal line. At the receiver input there are applied the transmission signal amplified by the line driver and the reception signal received from a distant transceiver via the signal line. The transmission signal at the receiver input of the transceiver has a much higher amplitude than the reception signal which is damped by the impedance of the signal line. To avoid that the transmission signal and signal distortion is coupled into the receiver a conventional broadband DSL transceiver comprises an echo canceling bridge to suppress the transmission signal at the signal input of the receiver. By minimizing the amplitude of the transmission signal applied to the input of the receiver the signal to noise ratio (SNR) of the reception signal is increased so that the achievable data bit rate of the xDSL transceiver is increased.

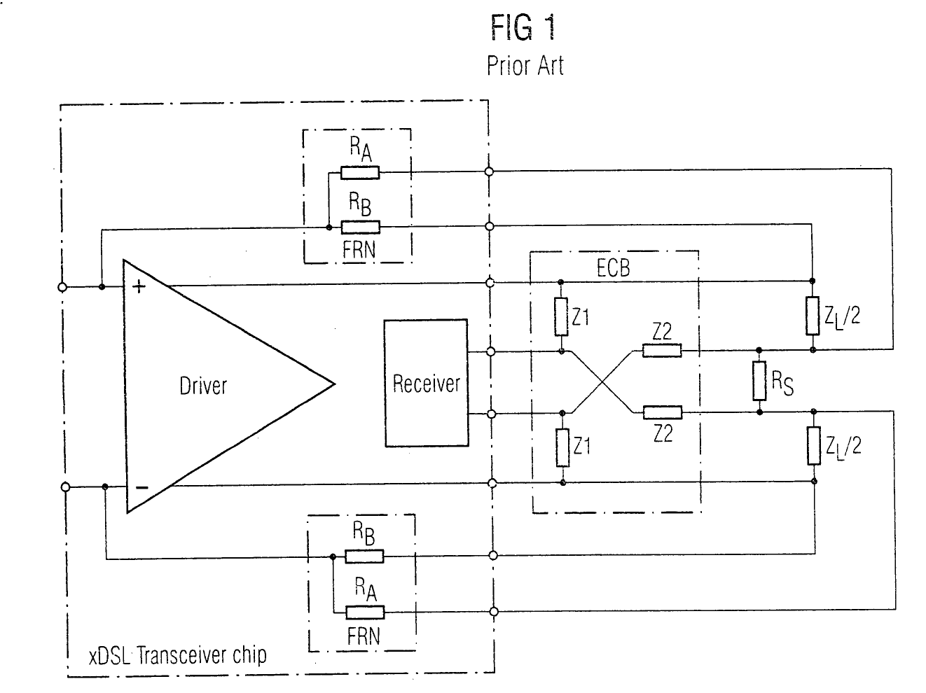

FIG. 1 shows a xDSL transceiver for transmitting and receiving a xDSL signal according to the state of the art. The xDSL transceiver comprises a line driver for driving a transmission signal applied to a signal input of the analog line driver via a signal line which is formed e.g. by a pair of copper wires. The output of the line driver is connected via a transformer (not shown) to the transmission line. The transmission line comprises a complex line impedance Z_{L}.

The xDSL transceiver according to the state of the art as shown in FIG. 1 further comprises a receiver for evaluating a reception signal received via the signal line and applied to a signal input of that receiver. As shown in FIG. 1 a sense resistor R_{S} is connected to the output terminal of the xDSL transceiver for sensing the output current of the line driver.

A feedback resistor network (FRN) is provided between the output terminal of the xDSL transceiver and the signal input of the analog line driver. The feedback resistor network FRN is provided for forming a synthesized termination output impedance Z_{T} of the xDSL transceiver as a product of the sense resistor R_{S} and a synthesis factor. The feedback resistor network FRN of the xDSL transceiver according to the state of the art is formed by at least two resistors R_{A}, R_{B}. The resistors of the feedback resistor networks are set so that the termination impedance Z_{T} of the xDSL transceiver matches the load impedance Z_{L} of the transmission line. The xDSL transceiver according to the state of the art comprises an active termination impedance formed by the sense resistor R_{S} and the feedback resistor network FRN. The feedback resistor network FRN is normally integrated with the line driver and the receiver on a xDSL transceiver chip.

The xDSL transceiver according to the state of the art as shown in FIG. 1 comprises an echo canceling bridge (ECB) which is provided for minimizing the transmission signal generated by the line driver at the signal input of the receiver. The echo canceling bridge ECB is formed fully differential and comprises two pairs of complex impedances Z1, Z2. Since the impedances Z1, Z2 of the echo canceling bridge ECB are not purely resistive but complex it is difficult to integrate these components on the xDSL transceiver chip. Accordingly the echo canceling bridge ECB of the xDSL transceiver according to the state of the art as shown in FIG. 1 is not integrated in the xDSL transceiver chip.

Consequently a first disadvantage of the xDSL transceiver according to the state of the art as shown in FIG. 1 is that the echo canceling bridge ECR is not integrated on the transceiver chip thus increasing the size of the xDSL transceiver line card and the production costs. Further it is more likely that the echo canceling bridge ECB which is provided outside the xDSL transceiver chip picks up noise from the surrounding e.g. the noise sensitivity of the receiver is increased.

An even more severe drawback of the conventional xDSL transceiver as shown in FIG. 1 is that because of the resistive sense resistor R_{S} the matching between the synthesized termination impedance Z_{T} of the xDSL transceiver and the load impedance Z_{L} of the transmission line is far from perfect so that the transmission gain is not a flat curve over the broadband frequency range i.e. the transmission gain is not constant.

Accordingly it is the main object of the invention to provide a xDSL transceiver having a synthesized termination output impedance Z_{T} which matches the load impedance Z_{L} of the transmission line over a broad frequency range.

This object is achieved by a broadband xDSL transceiver having the features of main claim 1.

The invention provides a broadband xDSL transceiver for transmitting and receiving signals in a broadband frequency range via a signal line which has a complex line impedance Z_{L},

wherein the xDSL transceiver comprises

a line driver for driving a transmission signal applied to a signal input of said line driver via said signal line,

a receiver for evaluating a reception signal received via said signal line and applied to a signal input of said receiver,

an echo canceling bridge for canceling the transmission signal at the signal input of said receiver,

a sense impedance (Z_{S}) connected to the signal line,

a feedback resistor network provided between the sense impedance (Z_{S}) and the signal input of said line driver for forming a synthesized termination impedance (Z_{T}) of the xDSL transceiver as a product of the sense impedance (Z_{S}) and an impedance synthesis factor (G),

wherein the sense impedance (Z_{S}) is a complex impedance so that the synthesized termination impedance (Z_{T}) matches the line impedance (Z_{L}) over all frequencies in the predetermined broadband frequency range.

In a preferred embodiment the feedback resistor network is programmable to adjust the impedance synthesis factor (G).

This has the advantage that the synthesized termination impedance (Z_{T}) of the xDSL transceiver is adaptable to different transmission lines having different load impedances (Z_{L}).

In a further preferred embodiment of the xDSL transceiver according to the present invention the echo canceling bridge is programmable to minimize the transmission signal at the signal input of the receiver.

In a preferred embodiment the line driver, the receiver, the feedback resistor network and the echo canceling bridge are integrated on a xDSL transceiver chip.

The integration of the echo canceling bridge on the xDSL transceiver chip has the advantage that the size of the xDSL transceiver line card is decreased.

A further advantage is that the production costs for a broadband xDSL transceiver are decreased.

A further advantage of integrating the echo canceling bridge within the xDSL transceiver chip is that the noise sensitivity of the receiver is diminished, i.e. it is less likely that the receiver picks up crosstalk from the surrounding.

In a preferred embodiment the xDSL transceiver is formed fully differential.

In a further embodiment the line driver comprises a signal output which is connected via a transformer to the signal line.

In a preferred embodiment the echo canceling bridge is formed by a resistor network comprising resistors which are integrated on the xDSL transceiver chip.

In the following preferred embodiments of the programmable xDSL transceiver according to the present invention are described with reference to the enclosed figures.

FIG. 1 shows an xDSL transceiver according to the state of the art;

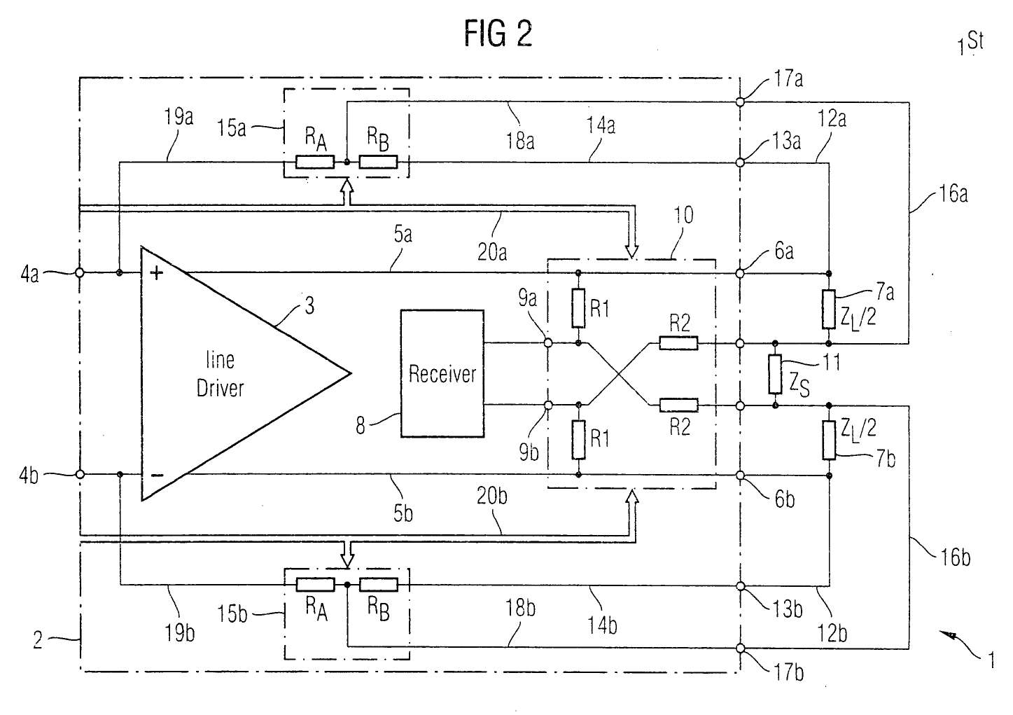

FIG. 2 shows a first embodiment of the broadband xDSL transceiver according to the present invention;

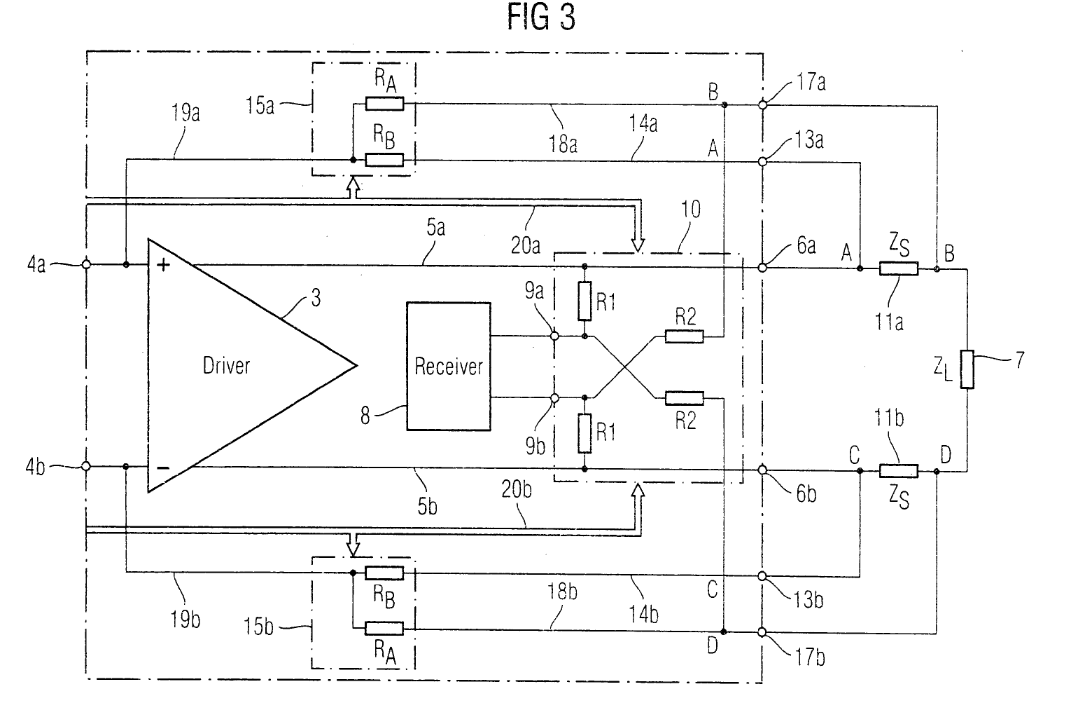

FIG. 3 shows a second embodiment of the broadband xDSL transceiver according to the present invention.

As can be seen from FIG. 2 the broadband xDSL transceiver 1 according to the present invention comprises a xDSL transceiver chip 2 including a line driver 3 for driving a transmission signal applied to a signal input 4a, 4b of the line driver 3. The line driver 3 amplifies the applied analog signal and outputs the amplified signal via internal signal lines 5a, 5b to output terminals 6a, 6b of the xDSL transceiver chip 2. The output terminal 6a, 6b of the xDSL transceiver chip 2 are connected via a transformer not shown to the transmission line having a load impedance Z_{L}. The impedance Z_{L} of the transmission line is complex. The transmission line is shown as impedances 7a, 7b in FIG. 2.

The xDSL transceiver 1 further comprises a receiver 8 for evaluating a reception signal received via the signal line and applied to a signal input 9a, 9b of the receiver 8. The xDSL transceiver 1 further comprises an echo canceling bridge 10 for canceling the transmission signal at the signal input 9a, 9b of the receiver 8. A sense impedance 11 is connected to the signal line. The sense impedance 11 of the xDSL transceiver 1 according to the present invention is like the impedance Z_{L} of the transmission line also complex. The sense impedance 11 having the complex impedance Z_{S} is in the embodiment shown in FIG. 2 not integrated in the xDSL transceiver chip 2.

The signal terminals 6a, 6b of the xDSL transceiver chip 2 are fedback via first feedback lines 12a, 12b to terminals 13a, 13b of the xDSL transceiver chip 2. The terminals 13a, 13b are connected via internal lines 14a, 14b to feedback resistor networks 15a, 15b. The sense impedance 11 of the xDSL transceiver 1 is connected via second external feedback lines 16a, 16b to terminals 17a, 17b of the xDSL transceiver chip 2. Theses terminals 17a, 17b are also connected via internal lines 18a, 18b to the feedback resistor networks 15a, 15b. The feedback resistor networks 15a, 15b each comprise at least two resistors R_{A}, R_{B}. Further the feedback resistor networks 15a, 15b include switches (not shown) so that the feedback resistance is programmable. The feedback resistor networks 15a, 15b are connected via internal feedback lines 19a, 19b to the line driver input 4a, 4b.

The echo canceling bridge 10 comprises two pairs of resistors R₁, R₂. The resistors R₁, R₂ do not have a complex impedance and are purely resistive so that they can be integrated easily on the xDSL transceiver chip 2. A first resistor R₁ is provided between the internal signal lines 5a, 5b and the signal input 9a, 9b of the receiver 8. The second resistor R₂ is connected between the complex sense impedance 11 and the signal input 9a, 9b of the receiver 8.

In a preferred embodiment the echo canceling bridge 10 is also programmable by means of internal programming control lines 20a, 20b so that the transmission signal generated by the line driver 3 at the signal input 9a, 9b of the receiver 8 is minimized. The programmable echo canceling bridge 10 comprises switches (not shown) which are controlled by means of the control lines 20a, 20b. The programming control lines 20a, 20b are connected to a microprocessor provided within the xDSL transceiver 1.

The feedback resistor networks 15a, 15b which are provided between the sense impedance 11 and the signal input 4a, 4b of the line driver 3 form a synthesized termination impedance Z_{T} of the xDSL transceiver 1.

The termination impedance Z_{T} of the xDSL transceiver 1 is the product of the sense impedance Z_{S} and an adjustable impedance synthesis factor (G):
Z_{T}=G·Z_{S} (1)

Optimal matching is achieved when the termination impedance Z_{T} is identical to the load impedance Z_{L} of the signal line:
Z_{T}=Z_{L} (2)

Consequently:
Z_{L}=G·Z_{S} (3)

The transmission gain of the transmit signal generated by the line driver 3 at the receiver input 9a, 9b is given by:

$${G}_{TX} = 1 - [ \frac{2}{1 + \frac{{R}_{2}}{{R}_{1}}} ] \cdot [ 1 - \frac{1}{2 ( 1 + \frac{{Z}_{S}}{{Z}_{L}} )} ] \qquad ( 4 )$$

When the load impedance Z_{L} is known it can be achieved that the transmission gain G_{TX} becomes zero by correctly dimensioning the resistances R₁, R₂ of the resistors within the echo canceling bridge 10 and the complex impedance Z_{S} of impedance 11.

Accordingly the echo canceling bridge 10 can be implemented in such a manner that the transmission signal is cancelled almost completely at the signal input of the receiver 8 thereby achieving a minimized crosstalk.

The gain of the reception signal G_{RX} given by:

$${G}_{RX} = \frac{1}{G} [ G + \frac{1 - G}{1 + \frac{{R}_{2}}{{R}_{1}}} ] \qquad ( 5 )$$

The resistors R₁, R₂ of the echo canceling bridge are dimensioned in such a way that the gain G is minimized. The synthesis factor G is chosen to be sufficiently high to have an acceptable reception signal gain G_{RX} but still low enough to achieve a low power dissipation.

When decreasing the impedance Z_{S} thus minimizing power dissipation this has as a trade off that the gain of the reception signal G_{RX} is decreased.

As can be seen from equation (4) since the sense resistor has also a complex impedance Z_{S} like the impedance of the signal line the quotient

$$\frac{{Z}_{S}}{{Z}_{L}}$$

is a constant so that G_{TX} is zero for a wide frequency range. Accordingly a flat transmission gain function of the transmission signal can be achieved for all frequencies in the predetermined broadband frequency range of the xDSL transceiver 1.

Since the impedance 11 is complex (Z_{S}) it is possible in the xDSL transceiver l to use an echo canceling bridge 10 which is pure resistive i.e. which comprises only resistors which do not have a complex impedance. Consequently the echo canceling bridge 10 of the xDSL transceiver 1 according to the present invention can be easily integrated of the xDSL transceiver chip 2. Accordingly the xDSL transceiver 1 achieves a superior matching and minimized crosstalk at the same time. Further the xDSL transceiver 1 according to the present invention is smaller in size and can be produced with lower costs.

FIG. 3 shows an alternative embodiment of the xDSL transceiver 1 according to the present invention.

In this embodiment the sense impedance Z_{S} is connected in series to the load impedance Z_{L}, i.e. with or without using of a transformer. The second resistor R₁ of the echo canceling bridge 10 is provided between the signal input 9a, 9b of the receiver 8 and terminals 17a, 17b in the feedback loop.

In typical applications the load impedance Z_{L} of the signal line is about 100 ohm. To minimize the impedance of the sensing resistor 11 and to minimize the power dissipation feedback loops are employed to form a synthesized termination impedance Z_{T} which matches the load impedance Z_{L} of the signal line, i.e. the termination impedance is typically also around 100 ohm. In a typical embodiment of the xDSL transceiver 1 according to the present invention the impedance synthesis factor G is about 7.

### REFERENCE LIST

1 xDSL transceiver
2 xDSL transceiver chip
3 line driver
4 signal input
5 internal line
6 transceiver terminal
7 load impedance
8 receiver
9 receiver input
10 echo canceling bridge
11 sense impedance
12 feedback line
13 terminal
14 internal line
15 feedback resistor network
16 feedback line
17 terminal
18 internal line
19 internal line
20 programming control lines

1-7. (canceled)

8. A broadband xDSL transceiver for transmitting and receiving signals in a predetermined broadband frequency range via a signal line which has a complex line impedance, the xDSL transceiver comprising:
(a) a line driver having a signal input and configured to drive a transmission signal received at the signal input, the line driver operably coupled to provide the transmission signal to the signal line;
(b) a receiver having a receiver signal input and configured to process a reception signal received at the receiver signal input via said signal line;
(c) an echo canceling bridge configured to cancel the transmission signal at the receiver signal input, the echo canceling bridge coupled to a control device via at least a first control line, the echo canceling circuit having an aspect that is programmable via at least the first control line;
(d) a sense impedance connected to the signal line;
(e) a feedback resistor network provided between the sense impedance and the signal input, the feedback resistor network operable to form a synthesized termination impedance of the xDSL transceiver as a product of the sense impedance and an impedance synthesis factor, the feedback resistor network configured to be controllably varied by the control device such that controllable variation of the feedback resistor network adjusts the impedance synthesis factor such that sysnthesized termination impedance matches the line impedance of said signal line;
wherein the sense impedance is a complex impedance and is configured such that the synthesized termination impedance substantially matches the line impedance over the predetermined broadband frequency range.

9. The broadband xDSL transceiver according to claim 8 wherein the line driver, the receiver, the feedback resistor network and the echo canceling bridge are integrated into an integrated circuit chip.

10. The broadband xDSL transceiver according to claim 8 wherein the line driver has a fully differential signal input.

11. The broadband xDSL transceiver according to claim 8 wherein the line driver comprises a signal output which is connected via a transformer to the signal line.

12. The broadband xDSL transceiver according to claim 11 wherein the echo canceling bridge comprises a resistor network.

13. The broadband xDSL transceiver according to claim 12, wherein the resistor network comprises two resistors having resistances R1 and R2 respectively, and wherein a gain GRX of the reception signal received by said receiver is given by:
GRX=(1/G)*(G+A);
wherein A=(1−G)/(1+R2/R1) and G is the impedance synthesis factor.

14. The broadband xDSL transceiver according to claim 13, wherein the feedback resistor network is programmed such that the synthesis factor is sufficiently high to have an acceptable gain GRX of the reception signal and sufficiently low to achieve a low power dissipation.

15. An arrangement for transmitting and receiving xDSL signals in a broadband frequency range via a signal line which has a complex line impedance, the arrangement comprising:
(a) a line driver having a signal input and configured to drive a transmission signal received at the signal input, the line driver operably coupled to provide the transmission signal to the signal line;
(b) a receiver having a receiver signal input and configured to process a reception signal received at the receiver signal input via said signal line;
(c) an echo canceling circuit configured to attenuate the transmission signal at the receiver signal input, the echo canceling circuit having an aspect that is programmable via at least a first control line;
(d) a sense impedance connected to the signal line, the sense impedance having a complex impedance;
(e) a variable feedback resistor network provided between the sense impedance and the signal input, the feedback resistor network operable to form a synthesized termination impedance of the arrangement as a function of the sense impedance and an impedance synthesis factor.

16. The arrangement according to claim 15 wherein the line driver, the receiver, the feedback resistor network and the echo canceling circuit are integrated into an integrated circuit chip.

17. The arrangement according to claim 15 wherein the line driver has a fully differential signal input.

18. The arrangement according to claim 15 wherein the echo canceling circuit includes devices that are substantially only resistive.

19. The arrangement according to claim 15 wherein the echo canceling circuit comprises a resistor bridge network.

20. The arrangement according to claim 15, wherein the echo canceling circuit includes at least one switchably connectable resistor.

21. The arrangement according to claim 18, wherein the echo canceling circuit includes at least one switchably connectable resistor.

22. An arrangement for transmitting and receiving xDSL signals in a broadband frequency range via a signal line which has a complex line impedance, the arrangement comprising:
(a) a line driver having a signal input and configured to drive a transmission signal received at the signal input, the line driver operably coupled to provide the transmission signal to the signal line;
(b) a receiver having a receiver signal input and configured to process a reception signal received at the receiver signal input via said signal line;
(c) an echo canceling circuit configured to attenuate the transmission signal at the receiver signal input, the echo canceling circuit having an aspect that is programmable via at least a first control line;
(d) a sense impedance connected to the signal line;
(e) a variable feedback resistor network provided between the sense impedance and the signal input, the feedback resistor network operable to form a synthesized termination impedance of the arrangement as a function of the sense impedance and an impedance synthesis factor.

23. The arrangement according to claim 22 wherein the line driver, the receiver, the feedback resistor network and the echo canceling circuit are integrated into an integrated circuit chip.

24. The arrangement according to claim 22 wherein the line driver has a fully differential signal input and is operable to drive a differential transmission signal.

25. The arrangement according to claim 23 wherein the echo canceling circuit includes devices that are substantially only resistive.

27. The arrangement according to claim 23 wherein the echo canceling circuit comprises a resistor bridge network.

28. The arrangement according to claim 23, wherein the echo canceling circuit includes at least one switchably connectable resistor.
